(19) United States
(12) Patent Application Publication
(10) Pub. No.: US 2026/0164211 A1
(43) Pub. Date: Jun. 11, 2026

(54) BINAURAL EXTERNALIZATION PROCESSING

(71) Applicant: Virtuel Works LLC, Aptos, CA (US)

(72) Inventors: Jean-Marc Marcel JOT, Aptos, CA (US); Earl Corban VICKERS, Seaside, CA (US)

(21) Appl. No.: 19/177,735

(22) Filed: Apr. 14, 2025

Related U.S. Application Data
(63) Continuation of application No. PCT/US23/76989, filed on Oct. 16, 2023.
(60) Provisional application No. 63/416,157, filed on Oct. 14, 2022.
(60) Provisional application No. 63/454,915, filed on Mar. 27, 2023.

(51) Int. Cl. H04S 7/00

(52) U.S. Cl. CPC H04S 7/304; H04S 7/306; H04S 2400/01; H04S 2400/03; H04S 2400/11; H04S 2420/01

(57) ABSTRACT

Binaural externalization processing methods according to the present invention operate as follows: receive an audio source signal comprising a set of elementary audio source signals to be subjected to externalization processing; apply directional processing to the audio source signal in order to generate a directional signal that is similar in timbre to the audio source signal; generate a tail input signal by applying downmix processing to the audio source signal, if it is composed of a plurality of elementary audio source signals; apply diffuse tail processing to the tail input signal to generate a tail output signal having diffuse localization, and that is similar in timbre to the audio source signal; combine the tail output signal and the directional signal to generate an externalized signal having directional localization, and that is similar in timbre to the audio source signal.

### CROSS-REFERENCE TO RELATED APPLICATIONS

This patent application is a continuation of PCT Patent Application No. PCT/US2023/076989, filed on Oct. 16, 2023, which claims the benefit of priority to U.S. Provisional Patent Application No. 63/416,157, filed on Oct. 14, 2022, and to U.S. Provisional Patent Application No. 63/454,915, filed on Mar. 27, 2023, which are all incorporated by reference herein in their entireties.

### BACKGROUND OF THE INVENTION

In both entertainment and professional applications, conventionally produced stereo or multi-channel audio content is frequently delivered over headphones or earbuds. A head-mounted wearable display device such as a Virtual Reality (VR) headset also operates as a binaural reproduction device if it incorporates a pair of loudspeakers (left and right), each transmitting its input signal to a respective ear of the listener wearing the device.

FIG. 1 Illustrates the binaural reproduction and the loudspeaker reproduction of various types of audio source signals. The types of audio content consumed via binaural reproduction devices include music, movies, podcasts, games, VR and audio conference or communication applications. In many use cases, the audio content is transmitted or delivered in the form of a single-channel (a.k.a. mono) audio source signal suitable for playback over a single loudspeaker (for instance a front-center loudspeaker, CF) or a two-channel stereo audio source signal suitable for playback over a pair of loudspeakers in conventional stereo arrangement (LF, RF). In some use cases, the audio source signal is delivered in an surround or immersive multi-channel or object-based audio distribution format such as Dolby Atmos, DTS-X or MPEG-H. A two-channel, multi-channel or object-based audio source signal is composed of or perceived as one or several single-channel audio source signals, each assigned an intended localization in auditory space relative to the listener's head position and orientation. The combination of an audio source signal and its intended localization data is referred to as an audio object. An audio object may represent e.g. a music instrument, a group of instruments, or the voice of a human talker.

The appreciation of binaural reproduction experiences by listeners is typically compromised by the unintended or unnatural perception of the localization of audio objects, wherein an audio object's localization as perceived by the listener does not match its intended localization:
(a) audio objects are often heard near or inside the listener's head even when their intended localization is distant;
(b) the localization of an audio object may seem more elevated vertically than intended. These observations are especially common for frontal audio objects, i.e. audio objects whose intended localization is substantially within the listener's visual field.

FIG. 2 illustrates a commonly reported listening experience during the binaural reproduction of a circular motion of an audio object in the horizontal plane, recorded with a dummy head microphone. As reported by one professional: “the most common case is to feel as though the source moves up as it passes in front.”

FIG. 3b illustrates the commonly perceived in-head localization in the binaural audio playback of two-channel stereo audio signals, whereas the intended localization, as experienced in a standard stereo loudspeaker reproduction and illustrated in FIG. 3a, is frontal and outside of the listener's head. In binaural reproduction, such discrepancies between intended and perceived localization are also commonly experienced with surround or immersive multi-channel or object-based audio source signals.

Known mitigating factors include the simulation of virtual or local room acoustic reverberation or reflections, the dynamic compensation of the listener's head motion, the customization of head-related and headphone-related transfer functions, and the provision of congruent visual information. These methods are not suitable or practical in all application scenarios because they require additional system complexity or particular listening conditions. Additionally, they may themselves cause undesirable side effects, such as audible and objectionable audio fidelity deteriorations relative to the audio source signal.

What is needed is a method for restoring the natural perception of external localization and frontal localization in the binaural reproduction of audio objects that does not cause objectionable audio fidelity deteriorations and does not add significant complexity in the realization of binaural audio reproduction systems.

### SUMMARY OF THE INVENTION

Methods according to the present invention are referred to collectively as externalization processing methods. A novel and unique benefit of these methods is to alleviate the frontal localization discrepancy illustrated in FIG. 2 and the external localization discrepancy illustrated in FIG. 3b, while preserving the timbre of any audio source signal.

Methods according to the present invention can be implemented in conjunction with the simulation of virtual or local room acoustic reverberation or reflections, the dynamic compensation of the listener's head motion, and the customization of head-related and headphone-related transfer functions.

Methods according to the present invention are applicable to enhancing the decoding and binaural reproduction of audio source signals delivered in immersive audio formats such as Dolby Atmos and MPEG-H, or rendered over head-mounted binaural reproduction devices for VR or augmented reality (AR) applications.

Binaural externalization processing methods according to the present invention operate as follows: receive an audio source signal comprising a set of elementary audio source signals to be subjected to externalization processing; apply directional processing to the audio source signal in order to generate a directional signal that is similar in timbre to the audio source signal; generate a tail input signal by applying downmix processing to the audio source signal, if it is composed of a plurality of elementary audio source signals; apply diffuse tail processing to the tail input signal to generate a tail output signal having diffuse localization, and that is similar in timbre to the audio source signal; combine the tail output signal and the directional signal to generate an externalized signal that has directional localization and is similar in timbre to the audio source signal.

### BRIEF DESCRIPTION OF DRAWINGS

FIG. 1 Illustrates the binaural reproduction and the loudspeaker reproduction of various types of audio source signals.

FIG. 2 Illustrates a commonly perceived trajectory in the binaural reproduction of a sound moving around the listener's head in the horizontal plane.

FIG. 3a illustrates the localization perceived by a listener in the reproduction of a two-channel stereo audio source signal in the standard stereo loudspeaker playback configuration.

FIG. 3b illustrates the commonly perceived in-head localization in the binaural reproduction of a two-channel stereo audio source signal.

FIG. 4 illustrates the intended localization in the binaural reproduction of a two-channel stereo audio source signal.

FIG. 5 is a signal flow diagram illustrating the directional processing of a 5-channel audio source signal, combining virtual loudspeaker simulation and synthetic reflections processing.

FIG. 6 is a signal flow diagram illustrating the binaural externalization processing of an audio source signal according to the present invention.

FIG. 7 is a flow chart illustrating the binaural externalization processing of an audio source signal according to the present invention.

FIG. 8 is a plot of the frequency-dependent interchannel coherence of a signal having diffuse localization in binaural reproduction.

FIG. 9a is a signal flow diagram illustrating the binaural externalization processing of an audio source signal composed of a set of single-channel elementary audio source signals, according to one embodiment of the present invention.

FIG. 9b depicts plots of ipsilateral magnitude and contralateral magnitude versus frequency of filters of FIG. 9a.

FIG. 10 is a signal flow diagram illustrating the binaural externalization processing of a two-channel stereo audio source signal, according to one embodiment of the present invention.

FIG. 11 is a signal flow diagram illustrating an embodiment of the diffuse tail processing of a two-channel tail input signal, according to an embodiment of the present invention.

FIG. 12a shows the transfer function of the directional processing block, according to one embodiment of the present invention.

FIG. 12b shows the transfer function of a binaural externalization processor, according to one embodiment of the present invention where directional processing is disabled.

FIG. 12c shows the transfer function of a binaural externalization processor, according to one embodiment of the present invention where directional processing is enabled.

FIG. 12d shows the impulse response of a binaural externalization processor, according to one embodiment of the present invention where directional processing is enabled.

FIG. 13 is a signal flow diagram illustrating the binaural externalization processing of a single-channel audio source signal, according to one embodiment of the present invention.

FIG. 14a is a signal flow diagram of a diffuse tail processing block designed to receive a single-channel tail input signal, according to one embodiment of the present invention.

FIG. 14b shows an embodiment of the process of generating left and right filter coefficients for FIG. 14a.

FIG. 15 is a signal flow diagram illustrating the Apply ICC function, according to one embodiment of the present invention.

FIG. 16 shows the magnitude frequency response of the filters used in the Apply ICC function, according to one embodiment of the present invention.

FIG. 17 is a flow chart summarizing the operation of a diffuse tail processing block designed to receive a single-channel tail input signal, according to one embodiment of the present invention.

FIG. 18a is a signal flow diagram of a diffuse tail processing block designed to receive a two-channel stereo tail input signal, according to one embodiment of the present invention.

FIG. 18b depicts a 4-channel noise generator according to one embodiment of the present invention.

FIG. 19 is a flow chart summarizing the operations performed by a diffuse tail processing block designed to receive a two-channel stereo tail input signal, according to one embodiment of the present invention.

### DETAILED DESCRIPTION OF THE INVENTION

### Existing Directional Processing Methods

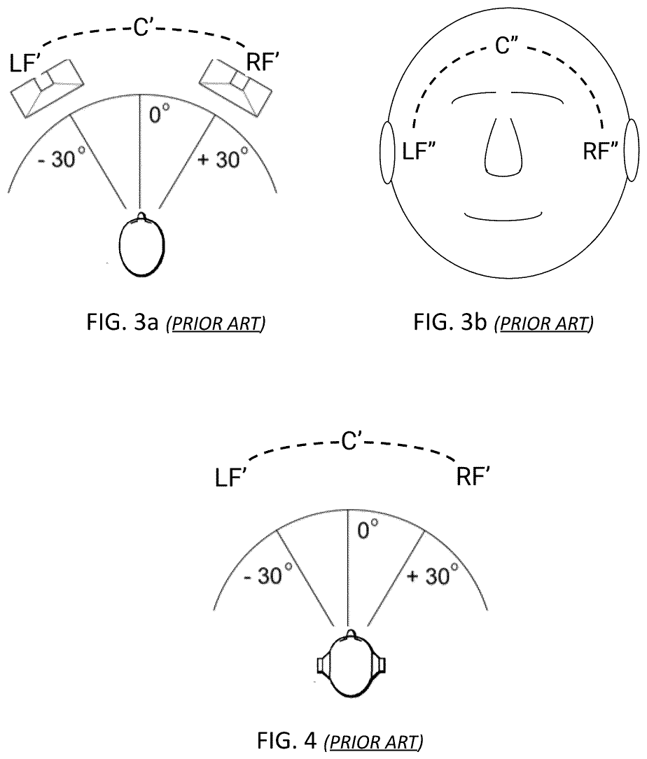

FIG. 3a illustrates, in a top-down view, the localization perceived by a listener in the reproduction of a two-channel stereo audio source signal in the conventional stereo loudspeaker playback configuration. The symbols (LF′), (RF′) and (C′) respectively represent the perceived localization of a left-channel audio object, a right-channel audio object, and a center-panned audio object transmitted equally over the left and right audio source signal channels. As shown in FIG. 3a, the perceived localization coincides respectively with the position of the left loudspeaker, the position of the right loudspeaker, and a notional front center position.

FIG. 3b illustrates the commonly perceived in-head localization in the binaural reproduction of two-channel stereo audio source signals. The symbols (LF″), (RF″) and (C″) respectively represent the perceived localization of a left-channel audio object, a right-channel audio object, and a center-panned audio object transmitted equally over the left and right audio source signal channels. As shown in FIG. 3b, the perceived localization coincides respectively with the left-ear position, the right-ear position, and a position near the center of the listener's head.

FIG. 4 illustrates, in a top-down view, the intended localization to be perceived by a listener in the binaural reproduction of a two-channel stereo audio source signal. In FIG. 4, the symbols (LF′), (RF′) and (C′) respectively represent the intended localization of a left-channel audio object, a right-channel audio object, and a center-panned audio object transmitted equally over the left and right audio source signal channels. As seen by comparing FIG. 4 and FIG. 3a, the intended localization coincides respectively with the notional positions of a left-front virtual loudspeaker, a right-front virtual loudspeaker, and a notional front center position.

As is well known in the art, directional processing methods have been developed with the goal of simulating, in binaural reproduction, the auditory experience of attending a live performance, or of listening to an audio recording via loudspeaker reproduction system. In the case of a two-channel stereo audio source signal, as illustrated in FIG. 4, the goal of directional processing is to simulate, in binaural reproduction, the auditory experience of playing back the audio source signal over a frontal stereo loudspeaker system. More generally, in the present document, a directional processing method is any method that can be used to convert a source audio signal into a two-channel directional signal, comprising a left-ear channel (L) and a right-ear channel (R), such that the binaural reproduction of the directional signal simulates the intended localization of the audio objects that compose the audio source signal.

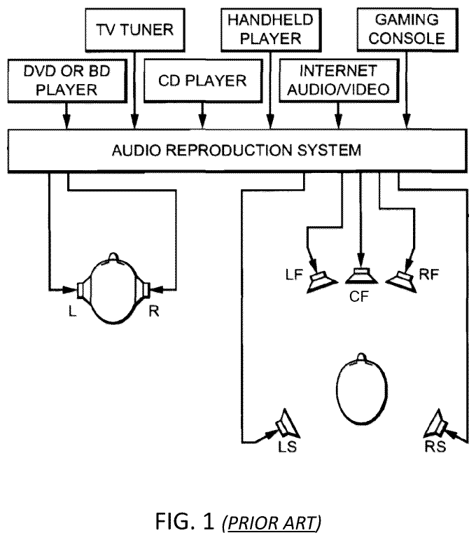

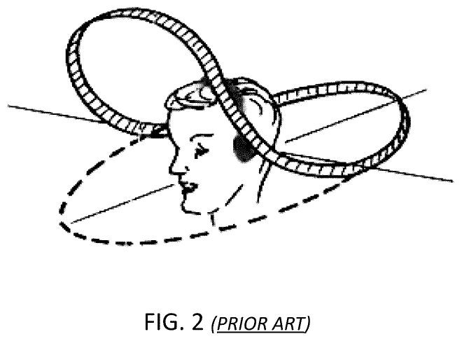

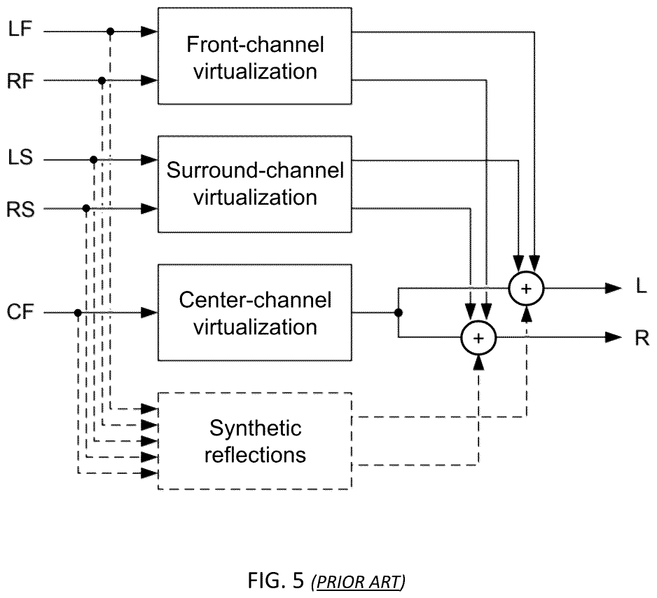

FIG. 5 illustrates the directional processing of a 5-channel audio source signal designed for playback in the standard surround-sound loudspeaker configuration shown in FIG. 1, comprising the following audio channels: left-front, center-front, right-front, left-surround, right-surround, respectively labeled (LF), (CF), (RF), (LS), (RS). As is well known in the art and illustrated in FIG. 5, directional processing is commonly performed by a process known as virtualization, based on audio signal filters that approximate a pair of head-related transfer functions (HRTF) for a given intended direction of apparent sound arrival. In FIG. 5, the virtualization processing is represented separately for the front audio channel pair, the surround audio channel pair, and the center audio channel.

Additionally, as illustrated in FIG. 5, a synthetic reflections processing block is used to simulate the experience of listening to the set of virtual loudspeakers in a virtual room. As is well known in the art, synthetic reflections processing methods, also referred to generally as artificial reverberation methods, are commonly employed in order enhance the perceived sense of naturalness of the listening experience in binaural reproduction.

Other well known techniques used in directional processors include direct-diffuse decomposition to render reverberation or ambience components already present in the source material as diffuse sound components, and up-mixing techniques to mitigate the incorrect matching of natural HRTF cues for audio objects panned across two or more virtual loudspeakers. These methods are equivalent to decomposing the audio source signal into a plurality of audio objects and applying virtualization processing to each of these component audio objects.

Directional processing methods applied to multi-channel or multi-object audio source signals suffer from the objectionable artifacts commonly observed for single-channel audio source signals:
in-head localization, spurious elevation or front-to-back confusion in the perceived localization of audio objects, especially for frontal audio objects;
timbre coloration, often attributed at least in part to the inclusion of synthetic reflections processing, causing the timbre of the processed signal to sound different from the timbre of the audio source signal.

### Binaural Externalization Processing

The binaural externalization processing methods of the present invention do not rely on the simulation of virtual loudspeakers or sound sources in a virtual room. Instead, they concentrate on delivering binaural cues that are experienced consistently in natural everyday listening conditions, regardless of the listening room, in the form of spatial relations between direct and diffuse sound-field components. For audio-only content (such as music or podcasts), binaural externalization processing can reduce listening fatigue and facilitate the auditory spatial interpretation of the intended audio scene. For audio-visual content, such as video, teleconference, VR or AR, it can alleviate cognitive load by improving the spatial coincidence of perceived auditory and visual cues.

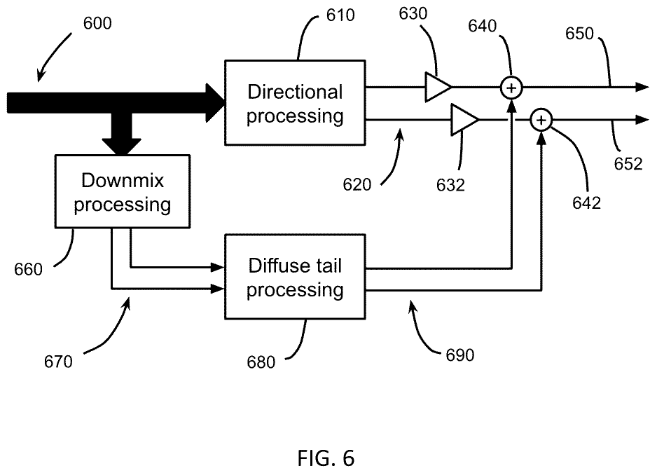

FIG. 6 is a signal flow diagram illustrating the binaural externalization processing of an audio source signal according to the present invention. The audio source signal 600 may be a single-channel signal, a two-channel signal, a multi-channel signal, an Ambisonic signal, an object-based signal or any combination thereof. The audio source signal 600 is fed to the directional processing block 610 and to the downmix processing block 660. Block 610 may be realized by any of the existing directional processing methods described in this document, and produces the directional signal 620. The downmix processing block 660 is necessary if the audio source signal is composed of a plurality of elementary audio source signals or comprises more than two channels. Block 660 outputs a single-channel or two-channel tail input signal 670, which is fed to the diffuse tail processing block 680. Block 680 produces the two-channel tail output signal 690. The outputs of directional processing block 610 are sent to dry gain 630 and dry gain 632, whose outputs are combined with the tail output signal 690 to produce the two-channel externalized signal (650, 652). As is well-known in the art, the audio signal processing operations described herein may be implemented indifferently in time-domain, frequency-domain, or short-time Fourier transform (STFT) domain.

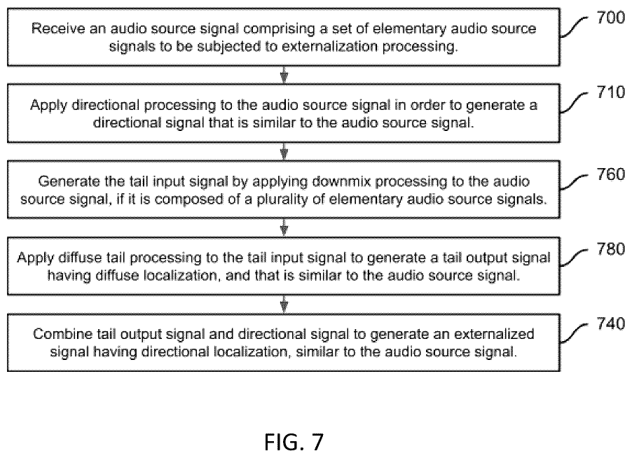

FIG. 7 is a flow chart illustrating the binaural externalization processing of an audio source signal according to the present invention. In step 700, an audio source signal is received comprising a set of elementary audio source signals to be subjected to externalization processing. In step 710, directional processing is applied to the audio source signal in order to generate a directional signal that is similar in timbre to the audio source signal. In step 760, a tail input signal is generated by applying downmix processing to the audio source signal, if the latter is composed of a plurality of elementary audio source signals. In step 780, diffuse tail processing is applied to the tail input signal to generate a tail output signal having diffuse localization, and that is similar in timbre to the audio source signal. In step 740, an externalized signal is generated by combining the tail output signal and the directional signal. The resulting externalized signal has directional localization and is similar in timbre to the audio source signal.

A two-channel audio signal having directional localization is one that, in binaural reproduction, is perceived as including at least one element with a specific apparent direction of sound arrival. If, on the other hand, a two-channel audio signal, that is not silent, does not have directional localization, then it is qualified as having diffuse localization. Diffuse localization is unspecific or blurry localization. Examples of audio signals having diffuse localization are the sound of a swarm of bees surrounding the listener, or the sound of room reverberation in common spaces. As is well known in the art, an objective diffuseness metric for a two-channel audio signal (L, R) is the interchannel coherence coefficient (denoted ICC). ICC is a function of frequency f:

$$ICC ( f ) = {\vert {G}_{LR} ( f ) \vert}^{2} / ( {G}_{LL} ( f ) \cdot {G}_{RR} ( f ) ) ,$$

G_{LR}(f) denotes the cross-spectral density of the two channels, and where
G_{LL}(f) and G_{RR}(f) denote, respectively, the spectral density of the L and R signals.

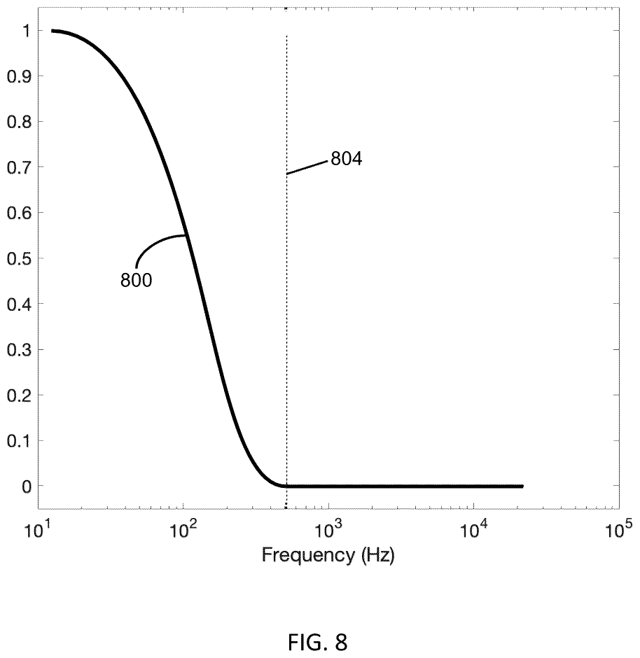

FIG. 8 is a typical simplified plot of the interchannel coherence of a two-channel signal having diffuse localization in binaural reproduction. The curve 800 represents ICC as a function of frequency. Above the transition frequency 804 (approximately 500 Hz) the two signals are mutually incoherent (also qualified as uncorrelated). As frequency decreases below the transition frequency, the coherence increases gradually and eventually reaches 1.0 at 0 Hz. At 0 Hz, the Left and Right signals are coherent (or correlated).

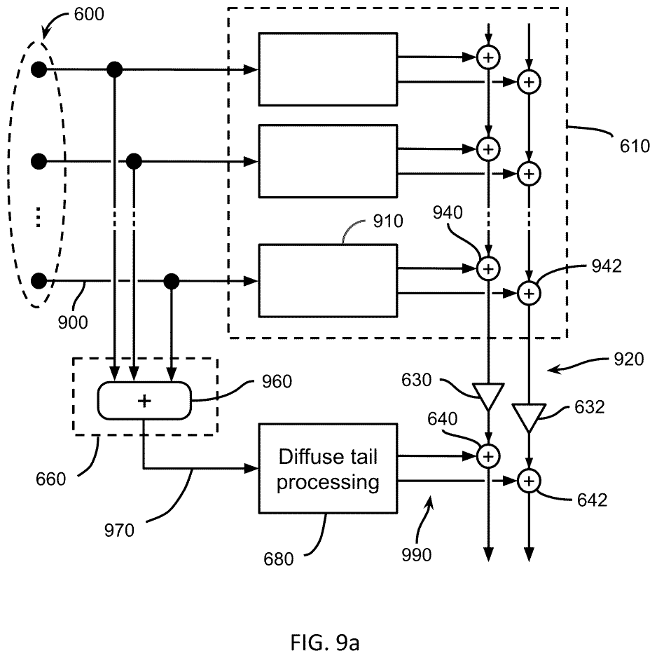

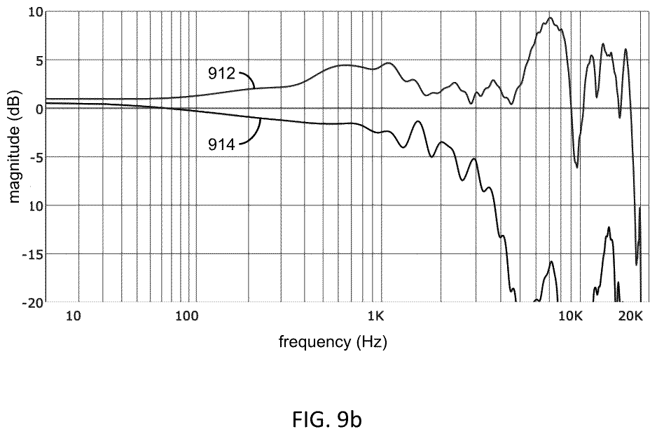

FIG. 9a is a signal flow diagram illustrating the binaural externalization processing of a multi-channel audio source signal 600 composed of a set of elementary single-channel audio source signals feeding a shared diffuse tail processing block 680, according to one embodiment of the present invention. Each elementary audio source signal (900) feeds a separate elementary directional processing block (910), whose output contributes to the directional signal 920 by use of the pair of adders (940, 942). The directional processing block 610 is the parallel association of the elementary directional processing blocks. The downmix block 660 performs the summation of the elementary single-channel source audio signals to produce the single-channel tail input signal 970. The tail processing block 680 produces the tail output signal 990, which is combined with the directional signal 920 to generate the externalized signal.

In the embodiment depicted in FIG. 9a, each one of the different elementary audio source signals may represent audio objects individually assigned to a different localization expressed by an azimuth angle and an elevation angle. Collectively, the set of audio objects may constitute an immersive multichannel audio source signal wherein each audio input channel is assigned a fixed position on a virtual sphere centered on the listener, relative to the front-center direction.

In one embodiment of the binaural externalization processor of FIG. 9a, each elementary directional processing block (910) outputs an elementary directional signal, by simulating the pair of HRTF filters for the direction assigned to its corresponding elementary audio object. FIG. 9b displays a pair of HRTF filters for azimuth and elevation angles respectively set to 90 degrees and 0 degrees. Curves 912 and 914 represent, respectively, the ipsilateral and contralateral magnitude HRTFs. In this embodiment, the HRTF filters used in all elementary directional processing blocks are diffuse-field compensated (i. e, the average of all their magnitude HRTFs over all directions in space is 0 dB at all frequencies).

As a result of employing diffuse-field compensated HRTF filters, setting one of the elementary directional processing modules to simulate a different position in 3D space does not require modifying the spectral equalization in the diffuse tail processing block, whose computation can therefore be shared among all objects. For the same reason, diffuse tail processing is not affected by HRTF individualization (customization of the directional processing to account for HRTF data representative of a different listener or head morphology).

An additional advantage of employing diffuse-field compensated HRTF filters in the directional processing block 680 according to the present invention is that the directional signal produced by the directional processing block is similar in perceived timbre to the audio source signal 600. As a general definition, in the context of the present invention, two audio signals are qualified as mutually similar if they are perceived as having substantially the same loudness and timbre, even though they may have different perceived localization. For instance, they may both have directional localizations differing in azimuth, elevation or externalization.

Two audio signals may be mutually similar (in their timbre), although one has directional localization while the other has diffuse localization. For instance, pseudo-stereo processing is a well-known example of audio signal processing function that generates a similar signal having diffuse localization from a single-channel audio signal.

Artificial reverberation processing can also be employed to generate a signal that has diffuse localization from a single-channel input audio signal. However, since artificial reverberation processing is designed to simulate the acoustics of a room (such as the synthetic reflections block in FIG. 5), it does not generate an output audio signal that is similar to its audio source signal. As is well known in the art of audio engineering, the timbre of a reverberator's output signal is noticeably different from the timbre of its input signal, in terms of tonal color and temporal resonance.

The following conditions must be verified in order to ensure that the externalized signal is similar in timbre to the source audio signal:
(a) The directional processing block 610 and the diffuse tail processing block 680 should preserve the timbre of the source audio signal 600 (in other words, the directional signal 620 and the tail output signal 690 should be similar in timbre to the source audio signal)
(b) the duration of the time response of the tail processing block 680 must be brief enough to avoid audible temporal smearing of transient or percussive sounds present in the source audio signal
(c) the loudness of the tail output signal 690 must be controlled and the dry gains (630, 632) adjusted accordingly so that the loudness of the externalized audio signal matches the loudness of the source audio signal.

Conditions (a) and (b) above rule out the inclusion of artificial reverberation processing (room simulation) in the tail processing block. In the following, this document describes binaural externalization processing embodiments that meet these conditions.

### Example Embodiment for a Two-Channel Stereo Audio Source Signal

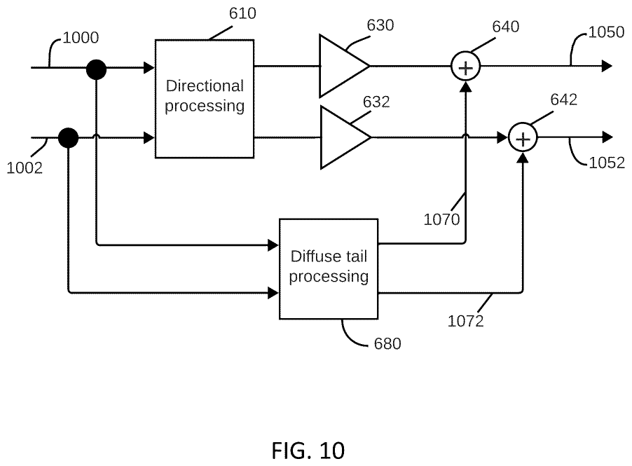

FIG. 10 is a signal flow diagram illustrating the binaural externalization processing of a two-channel stereo audio source signal, according to one embodiment of the present invention. The binaural externalization processing combines directional processing 610 with diffuse tail processing 680 that generates a tail output signal. The left-channel audio source signal 1000 is applied to the left input of directional processing block 610, as well as to one input of diffuse tail processing block 680. The right channel audio source signal 1002 is applied to the right input of directional processing block 610, as well as to a second input of the diffuse tail processing block 680. The outputs of directional processing 610 are sent to dry gain 630 and dry gain 632. The outputs of dry gain 630 and dry gain 632 are added to the outputs of diffuse tail processing block 680 using adders 640 and 642, respectively. The outputs of adders 640 and 642 constitute the respective externalized signals 1050 and 1052. In this particular embodiment, the downmix processing block 660 is omitted because the audio source signal is composed of a single elementary audio source signal, supplied in two-channel stereo format.

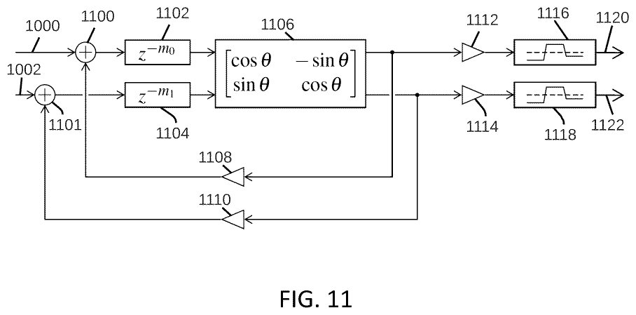

FIG. 11 is a signal flow diagram illustrating an embodiment of the diffuse tail processing of the two-channel tail input signal (1000, 1002), according to an embodiment of the present invention wherein the binaural externalization processor has the overall topology of a two-channel all-pass filter. Left audio source signal 1000 is added to left feedback signal 1108 by adder 1100, while right audio source signal 1002 is added to right feedback signal 1110 by adder 1001. The output of adder 1100 is delayed by m₀ samples by delay 1102, while the output of adder 1101 is delayed by m₁ samples by delay 1104. The outputs of delays 1102 and 1104 are sent to a 2×2 rotation matrix 1106. The left output of rotation matrix 1106 is sent to gain 1112 and feedback gain 1108; the right output of rotation matrix 1106 is sent to gain 1114 and feedback gain 1110. The outputs of gains 1112 and 1114 are sent to optional filters 1116 and 1118, respectively. The outputs of optional filters 1116 and 1118 are sent to tail output signals 1120 and 1122. For the system to be all-pass and timbre-preserving, gains 1112 and 1114 are set to (1−g₀²), feedback gains 1108 and 1110 are set to −g₀, and the dry gains 630 and 632 must be equal to g₀. The stability condition is |g₀|<1. For realizability, the 2-in, 2-out unitary system must be causal, with delays m₀ and m₁ being at least one-sample delays. Stereo crossfeed angle θ must be between 0 (representing no mixing) and λ/4 (representing maximum mixing between the channels). Typical parameter settings are:

$$Θ = \frac{π}{4} ;$$

average delay (m₁+m₀)/2=2.943 ms; channel delay difference

$$\frac{m 1 - m 0}{m1 + m0} = 28.74 \% ;$$

and feedback gain g₀=0.7214. Optional filters 1116 and 1118 may be implemented as 3-band, second-order dual shelving filters, which may be used to reduce the overall left-to-right and right-to-left crossfeed at high frequencies and the decorrelation caused by diffuse tail processing at low frequencies.

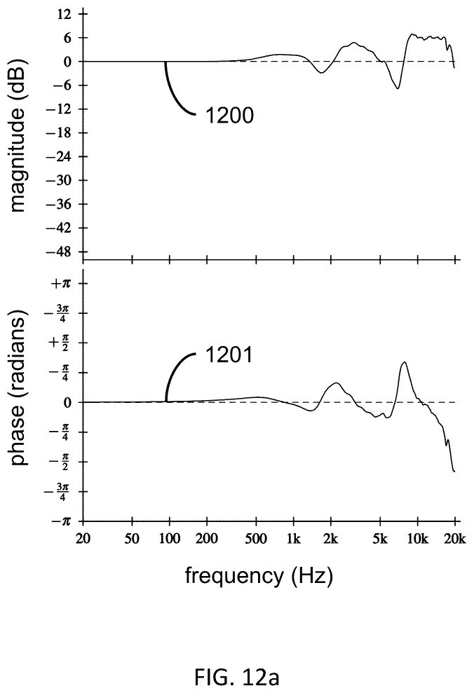

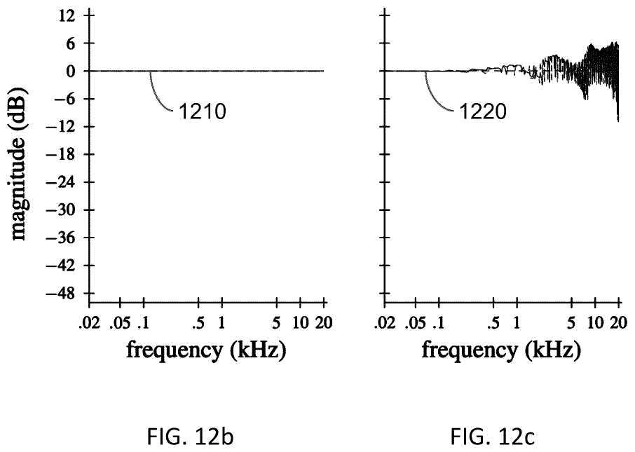

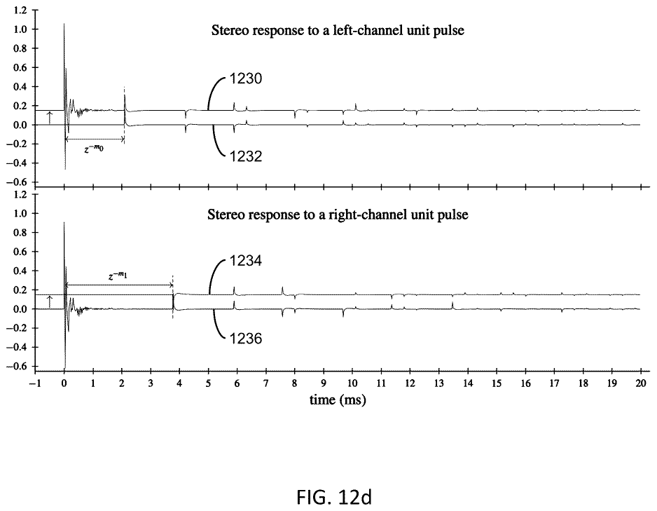

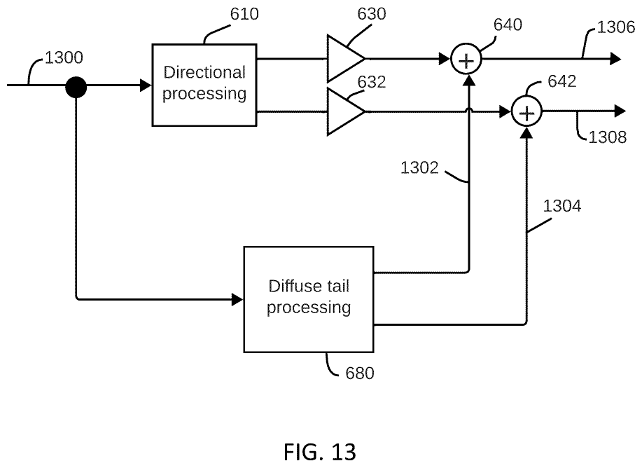

FIG. 12a shows an example of the transfer function of directional processing block 610 in an embodiment where the source audio signal 600 is a two-channel audio signal (as in FIG. 10) or a single-channel audio signal (as in FIG. 13), or of the elementary directional processing block 910 in FIG. 9a. In this example, the localization azimuth and elevation angles are both set at 0 degrees. The ipsilateral and contralateral HRTF filters are identical and diffuse-field compensated. As shown by the magnitude and phase frequency response curves 1200 and 1201, the directional processing block in this case is neutral up to about 300 Hz.

FIG. 12b shows the transfer function of the binaural externalization processor of FIG. 10 with the diffuse tail processing block of FIG. 11 and paragraph [58], and the directional processing block 610 disabled. As shown by the magnitude frequency response curve 1210, the binaural externalization processor has a perfectly neutral magnitude frequency response, confirming its all-pass character. If the impulse response of the tail processing block 680 is sufficiently brief, the externalized signal will be similar in timbre to the source audio signal.

FIG. 12c shows the transfer function of the same binaural externalization processor embodiment, but with the directional processing block 610 enabled to simulate frontal localization, per FIG. 12a. As shown by the magnitude frequency response curve 1220, this embodiment of the externalizer has a perfectly neutral magnitude frequency response up to about 300 Hz, because the directional processing block 610 is neutral in the low-frequency range. At higher frequencies, it is seen that the externalized signal remains similar to the source audio signal, since the magnitude frequency response curve 1220 remains within [−6, +6 dB].

FIG. 12d shows the impulse response of the same binaural externalization processor embodiment, confirming that its response is very brief (it dies out within approximately 20 ms). Plots 1230 and 1236 show, respectively, the left-to-left and right-to-right responses, which begin with the impulse response of the HRTF filter of FIG. 12a, followed by the response of the tail processing block. Plots 1232 and 1234 show, respectively, the left-to-right and right-to-left responses, i.e. the input-to-output cross-feed resulting from the diffuse tail processing.

FIG. 13 shows a signal flow diagram of an embodiment of the binaural externalization processor designed for a single-channel input audio source signal. Single-channel audio source signal 1300 is applied to directional processing block 610 as well as to diffuse tail processing block 680. The outputs of directional processing 610 are applied to dry gain 630 and dry gain 632. The outputs of dry gains 630 and 632 are added to the outputs 1302 and 1304 of diffuse tail processing block 680 using adders 640 and 642, respectively. The outputs of adders 640 and 642 constitute left and right externalized signals 1306 and 1308, respectively. In this particular embodiment, the downmix processing block 660 is omitted because the audio source signal is composed of a single elementary audio source signal.

### Example Embodiments Employing Diffuse Tail Processing Block Having a Noise-Based Response

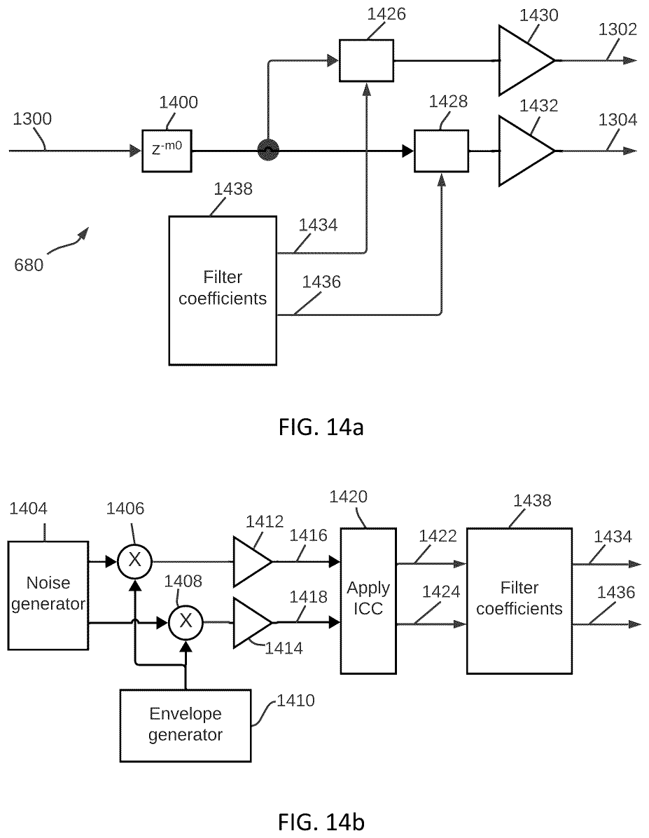

FIG. 14a is a signal flow diagram of an alternative embodiment of diffuse tail processing block 680, using decaying Gaussian white noise to help generate the diffuse tail signal. Wet delay 1400 delays single-channel audio source signal 1300 by m₀ samples. The delayed output from wet delay 1400 is sent to left filter 1426 and right filter 1428. Filter coefficients block 1438 sends noise filter coefficients 1434 and 1436 to filters 1426 and 1428, respectively. These coefficients are typically static (unchanging) and may be generated offline. Left and right filters 1426 and 1428 in turn filter the delayed output from wet delay 1400 using left and right filter coefficients 1434 and 1436, producing left and right filtered tail signals that are sent to wet gains 1430 and 1432, respectively. The outputs of wet gains 1430 and 1432 comprise tail output signals 1302 and 1304, respectively. With this embodiment of diffuse tail processing block 680 and those described in the following, the dry gains 630 and 632 are set according to wet gains 1430 and 1432 so that the loudness of the externalized signal matches the loudness of the audio source signal 600.

FIG. 14b shows an embodiment of the process of generating left and right filter coefficients 1434 and 1436. Noise generator 1404 produces two channels of mutually uncorrelated Gaussian white noise, which are sent to multipliers 1406 and 1408. Envelope generator 1410 generates an exponentially decaying envelope env(t)=g^{t}, where t is the time in samples, gain

$$g = 1 {0}^{\frac{- 60 / 20}{d * fs}} ,$$

d is the T60 decay time (e.g., 0.020 sec), and fs is the sample rate (e.g., 44100 Hz). The output of envelope generator 1410 is sent to the other inputs of multipliers 1406 and 1408 to produce enveloped noise. Optionally, other types of envelopes env, such as rectangular envelopes, can be used instead of exponentially decaying envelopes. The outputs of multipliers 1406 and 1408 are sent to normalizing gains 1412 and 1414, respectively, to produce normalized enveloped noise with unity sum-of-squares power in both channels. ICC input signals 1416 and 1418, which are the normalized enveloped noise produced by normalizing gains 1412 and 1414, respectively, are sent to the Apply ICC block 1420, which produces the partially-correlated Apply ICC output signals 1422 and 1424. Apply ICC block 1420 increases the inter-channel coherence at low frequencies, to match the properties of natural diffuse fields. Apply ICC output signals 1422 and 1424 are sent to the left and right inputs of filter coefficients block 1438, which stores left and right filter coefficients 1434 and 1436, respectively. The process of computing left and right filter coefficients 1434 and 1436 is typically just performed once; this computation may be performed offline. With this embodiment of diffuse tail processing block 680 and those described in the following, the temporal duration of the response of the tail processing block is kept brief enough (less than 40 ms) to ensure that the externalized signal is similar in timbre to the audio source signal.

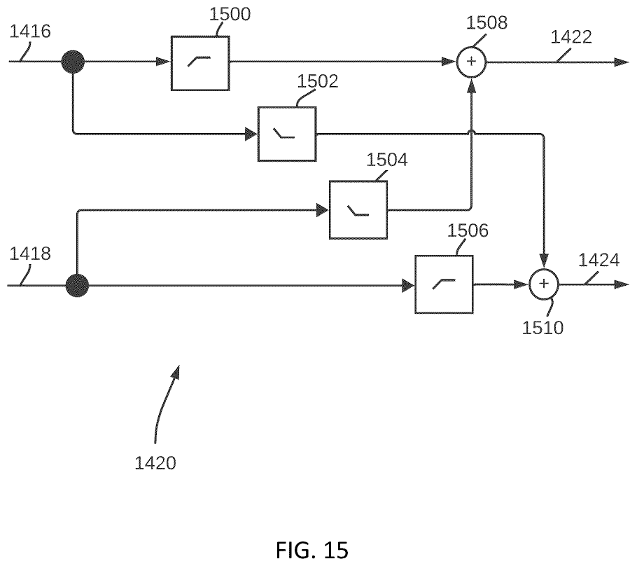

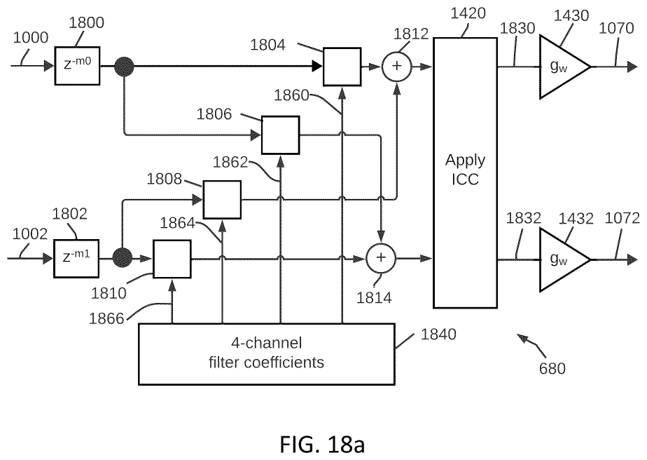

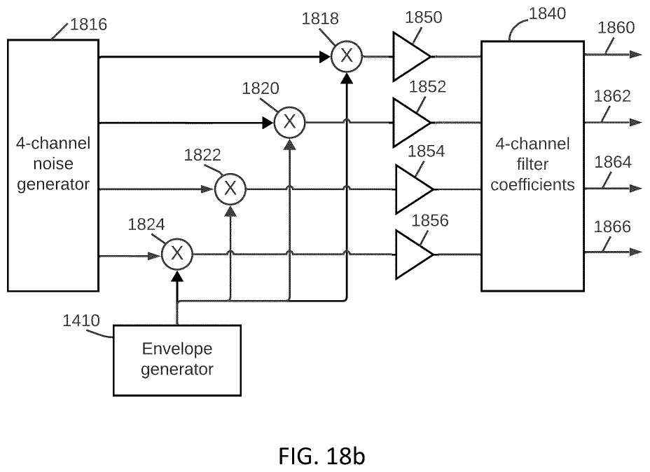

FIG. 15 shows the Apply ICC block 1420 in detail. In the single-input channel example of FIG. 14, the Apply ICC inputs 1416 and 1418 come from normalized enveloped noise. (In other embodiments, such as the two-input-channel example of FIG. 18, the Apply ICC inputs can come from filtered tail signals produced by convolving tail input signals with mutually uncorrelated noise.) In either case, in FIG. 15, left ICC input signal 1416 feeds filters 1500 and 1502, while right ICC input signal 1418 feeds filters 1504 and 1506. The outputs of filters 1500 and 1504 are added by adder 1508 to produce left ICC output signal 1422. The outputs of filters 1502 and 1506 are added by adder 1510 to produce right ICC output signal 1424. Filters 1500, 1502, 1504, and 1506 may be implemented using, for example, second-order time-domain shelving filters, as are well-known in the art; in alternative embodiments, they may be implemented in the STFT domain, etc. Apply ICC block 1420 can process a pair of short-duration noise signals, as in FIG. 14b, or an ongoing, real-time stream of filtered audio source signals, as in FIG. 18a.

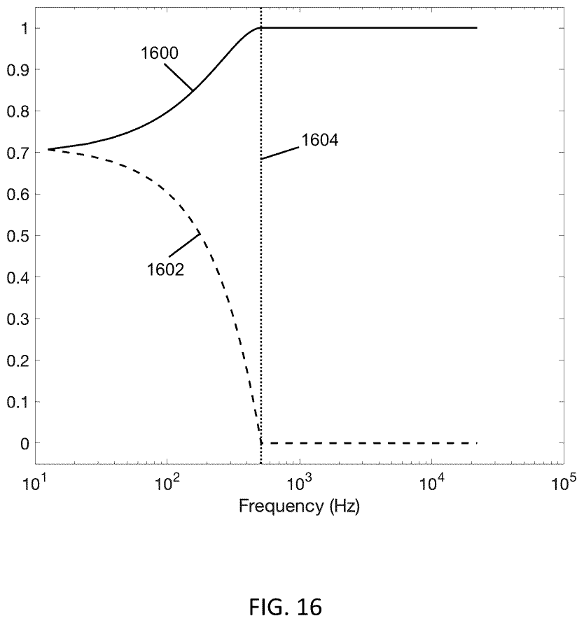

FIG. 16 shows the ideal responses of filters 1500, 1502, 1504, and 1506, such that Apply ICC 1420 becomes a 2-in, 2-out unity-gain system by design. Magnitude response curve 1600 (solid line) shows a value of cosine(theta(f)) for frequencies f less than or equal to cutoff frequency 1604 (vertical dotted line), where angle theta linearly ramps from pi/4 at DC to 0.0 at cutoff frequency 1604. Magnitude response curve 1600 has unity gain above cutoff frequency 1604. Power-complementary magnitude response curve 1602 (dashed line) shows a value of sine(theta(f)) for frequencies f less than or equal to cutoff frequency 1604, and a value of 0.0 for higher frequencies. Viewing Apply ICC 1420 as a matrix (where the matrix elements are filters), the diagonal matrix elements, filters 1500 and 1506, implement magnitude response curve 1600 to provide a gain of approximately 0.707 at DC, increasing to approximately unity gain above cutoff frequency 1604 (e.g. 500 Hz). Filters 1502 and 1504 implement power-complementary magnitude response curve 1602 (dashed line), providing a gain of approximately 0.707 at DC, decreasing to approximately zero gain above cutoff frequency 1604. Thus, in the system shown in FIG. 15, power is conserved at all frequencies, and the inter-channel coherence decreases below cutoff frequency 1604, becoming perfectly correlated at DC.

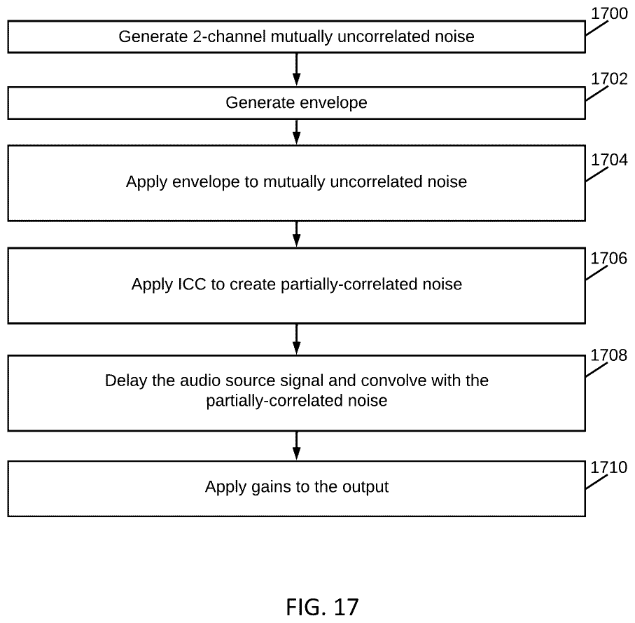

FIG. 17 is a flow chart summarizing the operations performed by diffuse tail processing block 680 in the case of a single-channel input, as shown in FIGS. 14a and 14b. In non-real-time (or offline) step 1700, noise generator 1404 generates two-channel mutually uncorrelated noise. In non-real-time step 1702, envelope generator 1410 generates a decaying exponential envelope env(t)=g^{t}, where t is the time in samples, gain

$$g = 1 {0}^{\frac{- 60 / 20}{d * fs}} ,$$

d is the T60 decay time, and fs is the sample rate. In non-real-time step 1704, each channel of the two-channel mutually uncorrelated noise is enveloped by exponentially decaying envelope env, producing enveloped noise dn(t, ch), where ch is the noise channel number. In alternative embodiments, envelope env could be another shape, such as rectangular, instead of exponentially decaying. In non-real-time step 1706, Apply ICC block 1420 increases the low-frequency inter-channel coherence between the two channels of enveloped noise, to produce partially-correlated enveloped noise. Thus, the Apply ICC block 1420 makes left and right Apply ICC output signals 1422 and 1424 more similar at low frequencies. Apply ICC output signals 1422 and 1424 are saved as filter coefficients in filter coefficients block 1438. In real-time step 1708, the audio source signal 1300 is delayed and convolved with the filter coefficients (partially-correlated enveloped noise) to produce an initial diffuse tail. In step 1710, gains are applied to the initial diffuse tail to produce tail output signals 1302 and 1304.

FIG. 18a is a signal flow diagram of an alternative embodiment of diffuse tail processing block 680 wherein a 2-channel audio source signal and enveloped Gaussian white noise are used to generate the tail. Left-channel audio source signal 1000 is delayed by m0 samples by wet delay 1800. The delayed output of wet delay 1800 is sent to filters 1804 and 1806. Similarly, right-channel audio source signal 1002 is delayed by m1 samples by wet delay 1802. The delayed output of wet delay 1802 is sent to filters 1808 and 1810. 4-channel filter coefficients block 1840 sends noise filter coefficients to the filter coefficient inputs of filters 1804, 1806, 1808, and 1810, respectively. Filters 1804, 1806, 1808, and 1810 filter the delayed audio source signals with four uncorrelated noise signals that serve as filter coefficients. The outputs of filter 1804 and filter 1808 are added by adder 1812, producing a left filtered tail signal that is sent to the left input of Apply ICC 1420. The outputs of filter 1806 and filter 1810 are added by adder 1814, producing a right filtered tail signal that is sent to the right input of Apply ICC 1420. Apply ICC 1420 increases the inter-channel coherence at low frequencies, to match the properties of natural diffuse fields. Apply ICC 1420 produces partially-correlated Apply ICC output signals 1830 and 1832, which are fed to wet gains 1430 and 1432, respectively. The outputs of wet gains 1430 and 1432 comprise tail output signals 1070 and 1072. In one embodiment, Apply ICC 1420 can be removed and its effects incorporated into filters 1804, 1806, 1808, and 1810. Many other topologies could be created by interchanging orders of operation, combining operations, or performing operations in different domains (including time-domain, frequency-domain, and STFT-domain): any such variations fall within the scope and spirit of this invention.

In FIG. 18b, 4-channel noise generator 1816 produces four channels of mutually uncorrelated noise, which are sent to multipliers 1818, 1820, 1822, and 1824. (These Gaussian white noise signals may be pre-selected by testing examples of pseudo-random noise generated using various seeds and evaluated according to some desired criteria, as in “Optimized Velvet-Noise Decorrelator”, by S. Schlecht, et al, which uses objective functions to minimize perceived coloration. Other audio signals, such as “velvet noise” can be used instead of Gaussian white noise.) Envelope generator 1410 computes decaying exponential envelope env(t)=g^{t}, where t is the time in samples, gain

$$g = 1 {0}^{\frac{- 60 / 20}{d * fs}} ,$$

d is the T60 decay time (e.g., 0.020 sec), and fs is the sample rate. Optionally, other types of envelopes env, such as rectangular envelopes, can be used instead of exponentially decaying envelopes. The output of envelope generator 1410 is sent to the other inputs of multipliers 1818, 1820, 1822, and 1824, to produce exponentially decaying white noise. The outputs of multipliers 1818, 1820, 1822, and 1824 are scaled by normalizing gains 1850, 1852, 1854, and 1856, respectively, to produce normalized enveloped noise with unity sum-of-squares power in each channel. The outputs of normalizing gains 1850, 1852, 1854, and 1856 are stored in 4-channel filter coefficients block 1840. The process of computing the 4-channel filter coefficients is typically just performed once; this computation may be performed offline.

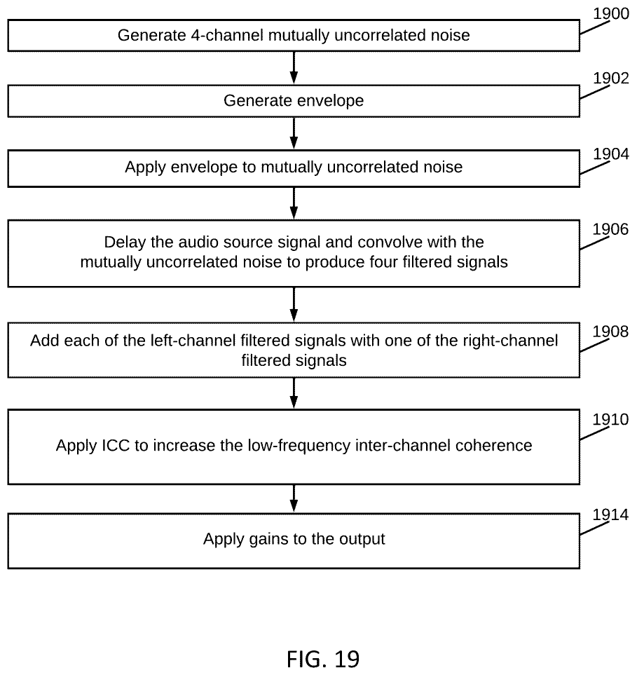

FIG. 19 is a flow chart of an embodiment of diffuse tail processing block 680, in which a 2-channel audio source signal and enveloped Gaussian white noise are used to generate the tail, as shown in FIG. 18. In step 1900, four-channel noise generator 1816 generates four-channel mutually-uncorrelated white noise. In step 1902, envelope generator 1410 generates exponentially decaying envelope env(t)=g^{t}, where t is the time in samples, gain

$$g = 1 {0}^{\frac{- 60 / 20}{d * fs}} ,$$

d is the T60 decay time, and fs is the sample rate. Step 1904 multiplies each channel of the four-channel mutually-uncorrelated white noise signal with envelope env, producing enveloped noise dn(t, ch), where ch is the noise channel number. In alternative embodiments, envelope env could be another shape, such as rectangular, instead of exponentially decaying. Step 1906 delays audio source signals 1000 and 1002 by m0 and m1 samples, respectively, and convolves the resulting delayed audio source signals with channels of enveloped noise dn to produce two left-channel filtered audio source signals and two right-channel filtered audio source signals. Specifically, filter 1804 convolves the output of delay 1800 with the output of multiplier 1818; filter 1806 convolves the output of delay 1800 with the output of multiplier 1820; filter 1808 convolves the output of delay 1802 with the output of multiplier 1822; and filter 1810 convolves the output of delay 1802 with the output of multiplier 1824. In step 1908, each of the left-channel filtered signals is added with one of the right-channel filtered signals. Specifically, adder 1812 adds the outputs of filters 1804 and 1808, while adder 1814 adds the outputs of filters 1806 and 1810, together producing an initial diffuse tail. In step 1910, Apply ICC 1420 increases the low-frequency inter-channel coherence between the initial diffuse tail (i.e., the outputs of adders 1812 and 1814), to produce a partially-correlated diffuse tail, thus making left and right Apply ICC output signals 1830 and 1832 more similar at low frequencies. In step 1914, wet gains 1430 and 1432 are applied to Apply ICC output signals 1830 and 1832, producing tail output signals 1070 and 1072, respectively.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show particulars of the present invention in more detail than is necessary for the fundamental understanding of the present invention, the description taken with the drawings making apparent to those skilled in the art how the several forms of the present invention may be embodied in practice. It is to be understood that the same or equivalent functions and sequences may be accomplished by different embodiments that are also intended to be encompassed within the spirit and scope of the invention.

What is claimed is:

1. A method of processing an audio source signal to generate an externalized signal, the method comprising:
receiving the audio source signal;
generating a directional signal by applying directional processing to the audio source signal;
generating a tail input signal derived from the audio source signal;
applying diffuse tail processing to the tail input signal to generate a tail output signal having diffuse localization, and that is representative to the audio source signal; and
combining the tail output signal and the directional signal to generate the externalized signal having directional localization.

2. The method of claim 1, wherein the method is implemented on an audio reproduction system.

3. The method of claim 1 further comprising applying downmixing to the audio source signal prior to applying the diffuse tail processing.

4. The method of claim 1 further comprising applying gain correction to the directional signal prior to combining the directional signal and the tail output signal.

5. The method of claim 1, wherein applying the diffuse tail processing includes applying a delay network.

6. The method of claim 1, wherein applying the diffuse tail processing includes applying a rotation matrix.

7. The method of claim 1, wherein the externalized signal is representative of the audio source signal.

8. The method of claim 1, wherein the audio source signal is a multi-channel audio source signal.

9. The method of claim 1, wherein at least a portion of the method is implemented by one or more processors.

10. A device for processing an audio source signal to generate an externalized signal, the device comprising:
a memory; and
at least one processor configured for:
receiving the audio source signal;
generating a directional signal by applying directional processing to the audio source signal;
generating a tail input signal derived from the audio source signal;
applying diffuse tail processing to the tail input signal to generate a tail output signal having diffuse localization, and that is representative to the audio source signal; and
combining the tail output signal and the directional signal to generate the externalized signal having directional localization.
